(19) United States
(12) Patent Application Publication
(10) Pub. No.: US 2026/0025692 A1
(43) Pub. Date: Jan. 22, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/998,044

(22) PCT Filed: Aug. 2, 2022
(86) PCT No.: PCT/CN2022/109755

§ 371 Date: Jan. 23, 2025

(51) Int. Cl. H04W 24/10; H04W 56/00; H04W 84/12

(52) U.S. Cl. CPC H04W 24/10; H04W 56/0015; H04W 84/12

(57) ABSTRACT

A communication method, including: determining a first radio frame, where the first radio frame includes at least one sensing measurement period, and the sensing measurement period is configured for an SBP responder to serve as proxy for an SBP initiator to establish sensing measurement of wireless local area network (WLAN); and transmitting the first radio frame.

### CROSS-REFERENCE TO RELATED APPLICATIONS

The present application is a U.S. National Stage of International Application No. PCT/CN2022/109755, filed on Aug. 2, 2022, the contents of all of which are incorporated herein by reference in their entireties for all purposes.

### BACKGROUND OF THE INVENTION

As the mobile communication technology advances rapidly, the wireless fidelity (Wi-Fi) technology has made tremendous progress in terms of transmission rate as well as throughput. Currently, research on the Wi-Fi technology includes 320 Mhz bandwidth transmission, aggregation and cooperation of a plurality of frequency bands, and so on, and its main application scenarios include video transmission, augmented reality (AR), and virtual reality (VR), and so on.

### SUMMARY OF THE INVENTION

Examples of the present disclosure relate to the technical field of mobile communication, and provide a communication method, an electronic device, and a storage medium.

According to a first aspect, the examples of the present disclosure provide a communication method. The method is performed by a sensing by proxy (SBP) initiator, and includes:
determining a first radio frame, where the first radio frame includes at least one sensing measurement period, and the sensing measurement period is configured for an SBP responder to serve as proxy for the SBP initiator to establish sensing measurement of wireless local area network (WLAN); and transmitting the first radio frame.

According to a second aspect, the examples of the present disclosure further provide a communication method. The method is performed by a sensing by proxy (SBP) responder, and includes:
receiving a first radio frame, where the first radio frame includes at least one sensing measurement period, and the sensing measurement period is configured for the SBP responder to serve as proxy for an SBP initiator to establish sensing measurement of wireless local area network (WLAN); and establishing the sensing measurement of the wireless local area network (WLAN) with proxy for the SBP initiator according to the first radio frame.

According to a third aspect, the examples of the present disclosure further provide an electronic device. The electronic device includes a memory, one or more processors, and a computer program stored on the memory and runnable on the one or more processors. When the program executed by the one or more processors, the one or more processors are collectively configured to:
determine a first radio frame, where the first radio frame includes at least one sensing measurement period, and the sensing measurement period is configured for an SBP responder to serve as proxy for the SBP initiator to establish sensing measurement of wireless local area network (WLAN); and transmit the first radio frame.

According to a fourth aspect, the examples of the present disclosure further provide an electronic device. The electronic device includes a memory, one or more processors, and a computer program stored on the memory and runnable on the one or more processors. When the program executed by the one or more processors, the one or more processors are collectively configured to implement the method according to one or more examples of the present disclosure in the second aspect.

According to a fifth aspect, the examples of the present disclosure further provide a non-transitory computer-readable storage medium, storing one or more computer programs configured to be executed by one or more processors of a processing device, and the one or more programs include instructions. Where the instructions, when executed by the processing device, cause the processing device to implement the method according to one or more examples of the present disclosure in the first aspect.

According to a sixth aspect, the examples of the present disclosure further provide a non-transitory computer-readable storage medium, storing one or more computer programs configured to be executed by one or more processors of a processing device, and the one or more programs include instructions. Where the instructions, when executed by the processing device, cause the processing device to implement the method according to one or more examples of the present disclosure in the second aspect.

Additional aspects and advantages of the examples of the present disclosure will be set forth in the following description, and these additional aspects and advantages will be apparent from the following description, or learned by practice of the present disclosure.

### BRIEF DESCRIPTION OF DRAWINGS

In order to describe the technical solutions in examples of the present disclosure more clearly, the accompanying drawings required for describing the examples of the present disclosure are briefly described below. Obviously, the accompanying drawings in the following description are merely some examples of the present disclosure. Those of ordinary skill in the art can also derive other accompanying drawings from these accompanying drawings without creative efforts.

FIG. 1 is a first flowchart of a communication method according to an example of the present disclosure;

FIG. 2 is a first schematic diagram of a first instance of an example of the present disclosure;

FIG. 3 is a second schematic diagram of a first instance of an example of the present disclosure;

FIG. 4 is a third schematic diagram of a first instance of an example of the present disclosure;

FIG. 5 is a schematic diagram of a second instance of an example of the present disclosure;

FIG. 6 is a second flowchart of a communication method according to an example of the present disclosure;

FIG. 7 is a third flowchart of a communication method according to an example of the present disclosure;

FIG. 8 is a first schematic structural diagram of an electronic device according to an example of the present disclosure;

FIG. 9 is a second schematic structural diagram of an electronic device according to an example of the present disclosure; and

FIG. 10 is a third schematic structural diagram of an electronic device according to an example of the present disclosure.

### DETAILED DESCRIPTION OF THE INVENTION

In the embodiments of the present disclosure, the term “and/or”, which is an association relation describing an associated object, indicates that there may be three relations. For example, A and/or B may indicate three situations: A exists alone, A and B exist at the same time, and B exists alone. The character “/” generally indicates that successive association objects are in an “or” relation.

In the examples of the present disclosure, the term “a plurality” refers to two or more, and other quantifiers are understood similarly.

Description will be made in detail to examples here, and their instances are illustrated in the accompanying drawings. When the following description relates to the accompanying drawings, the same numbers in different accompanying drawings denote the same or similar elements, unless indicated otherwise. The embodiments described in the following examples do not denote all embodiments consistent with the present disclosure. On the contrary, the embodiments are merely instances of devices and methods consistent with some aspects of the present disclosure, as recited in the appended claims.

The terms used in the present disclosure are merely to describe the specific examples, instead of limiting the present disclosure. The singular forms such as “a/an”, “the”, and “this” used in the present disclosure and the appended claims are also intended to include the plural forms unless clearly stated otherwise in the context. It should also be understood that the term “and/or” as used here refers to and includes any or all possible combinations of one or more of associated items listed.

It should be understood that although the terms “first”, “second”, “third”, etc. may be employed in the present disclosure to describe various information, such information should not be limited to these terms. These terms are merely used to distinguish the same type of information from each other. For example, first information can also be referred to as second information, and similarly, second information can also be referred to as first information, without departing from the scope of the present disclosure. Depending on the context, the word “if” as used here can be interpreted as “at the time of”, “when”, or “in response to determining”.

The technical solutions in the examples of the present disclosure will be clearly and completely described below with reference to the accompanying drawings in the examples of the present disclosure. Obviously, the described examples are merely some examples rather than all examples of the present disclosure. Based on the examples of the present disclosure, all other examples derived by those of ordinary skill in the art without creative efforts fall within the scope of protection of the present disclosure.

In the research on the Wi-Fi technology, the aggregation and cooperation of the plurality of frequency bands means simultaneous communication between devices in 2.4 GHz, 5.8 GHz, 6 GHz and other frequency bands. In the scenario of simultaneous communication between devices in the plurality of frequency bands, a new media access control (MAC) mechanism needs to be defined for management. Further, the aggregation and cooperation of the plurality of frequency bands are expected to be able to support low-latency transmission.

Currently, the maximum bandwidth to be supported in the aggregation and cooperation technology of the plurality of frequency bands is 320 MHz (160 MHz+160 MHz). In addition, 240 MHz (160 MHz+80 MHz) and other bandwidths supported by existing standards are also supported possibly.

In the current Wi-Fi technology in research, the wireless local area network (WLAN) sensing technology is supported possibly, for example, location discovery, proximity detection and presence detection in dense environments (such as home and corporate environments). During WLAN Sensing, the identities of a station (STA) device and an access point (AP) device are typically interchangeable, for example, both can act as an initiator device (a sensing initiator or a sensing transmitter). When acting as a sensing initiator or a sensing transmitter, the AP can communicate with a number of STAs simultaneously, but the STAs do not have the above function and can only communicate one-to-one with a single responder (a sensing responder). In this way, the spectrum resources are wasted, and the delay is increased. For communication scenarios with high delay requirements, the delay requirements may not be satisfied. In order to solve the problems, a method for measurement of the WLAN sensing with AP proxy for the STA, that is, sensing by proxy (SBP), has been proposed. Accordingly, a method of negotiating a measurement period during SBP needs to be provided to perfect an SBP establishment mechanism.

The examples of the present disclosure provide a communication method, an electronic device and a storage medium, and solve the problem that a sensing by proxy (SBP) request becomes an invalid signaling message, resulting in waste of signaling resources.

The method and device are based on the same application concept. Since the method and device have the similar principles for solving problems, the device and method may be implemented with reference to each other, without repeated portions described in detail.

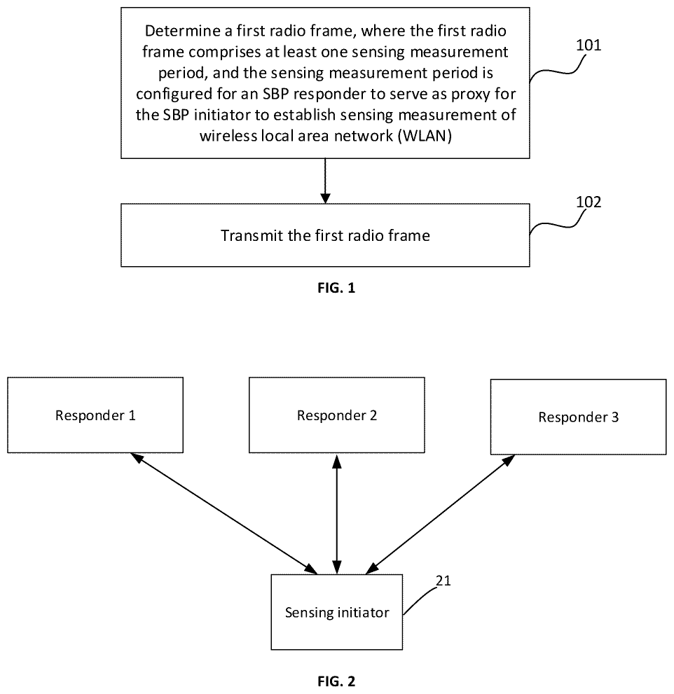

As shown in FIG. 1, the examples of the present disclosure provide a communication method. Optionally, the method may be performed by a sensing by proxy (SBP) initiator, such as a station (STA) device. The method may include steps 101 and 102.

Step 101, a first radio frame is determined, where the first radio frame includes at least one sensing measurement period, and the sensing measurement period is configured for an SBP responder to serve as proxy for the SBP initiator to establish sensing measurement of wireless local area network (WLAN).

As a first instance, with reference to FIGS. 2-4, an architecture of the WLAN sensing and a WLAN sensing process applied by a method for sensing measurement by proxy provided in the example of the present disclosure are first introduced.

FIG. 2 is a schematic diagram of an architecture of WLAN sensing (a process). A sensing initiator 21 (or an initiator) initiates the WLAN sensing (for example, initiates a WLAN sensing session). A plurality of sensing responders (or sensing receivers) or responders, such as responder 1, responder 2 and responder 3 shown in FIG. 2, may respond to the WLAN sensing. When the sensing initiator 21 initiates the WLAN sensing, a plurality of associated or non-associated sensing responders of the WLAN sensing may respond.

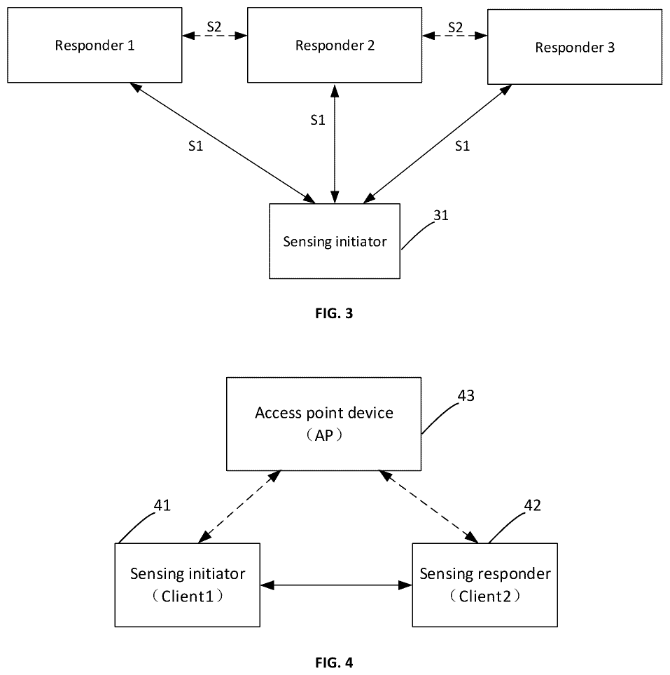

With reference to FIG. 3, the sensing initiator 31 communicates with the sensing responders through communication connection, for example, communication connection S1. The sensing responders communicate with each other through communication connection S2.

Each sensing initiator 31 may be a client. Each sensing responder (in this instance, responder 1 to responder 3) may be a station (STA) device or an access point (AP) device. Furthermore, the STA and the AP may assume a plurality of roles in the WLAN sensing process. For example, the STA may also act as a sensing initiator in the WLAN sensing process. The sensing initiator 31 may be a sensing transmitter, a sensing receiver, both or neither. In the WLAN sensing process, the sensing responder may also be a sensing transmitter, a sensing receiver, or both.

As another architecture, as shown in FIG. 4, both the sensing initiator 41 and the sensing responder 42 may be clients, and may communicate with each other by being connected to a same access point (AP) device 43. In FIG. 4, client 1 is the sensing initiator 41, and Client 2 is the sensing responder 42.

Generally, when acting as a sensing initiator or a sensing transmitter, the STA does not have a function of communicating with a plurality of receivers simultaneously, such that a proxy device (for example, AP) is required to serve as proxy for the STA to perform triggered based sounding (TB) sensing measurement, so as to improve efficiency of sensing measurement.

During SBP, the SBP initiator may have parameter requirements for trigger-based (TB) sensing measurement, such as a number of sensing responders participating in TB sensing measurement, bandwidth of sensing measurement, a number of spatial streams supported by sensing measurement, and time period information of measurement. The SBP initiator may carry one or more pieces of information about the sensing measurement period required by the SBP initiator in the first radio frame, for example, a number of required sensing measurement periods. For another example, a sensing measurement period identification bit may be included in the first radio frame. For example, in a case that the sensing measurement period identification bit is 1, it indicates that the sensing measurement occurs once; or in a case that the sensing measurement period identification bit is greater than 1, for example, N, it indicates that the sensing measurement occurs N times.

The sensing measurement period is configured for the SBP responder to serve as proxy for the SBP initiator to establish the sensing measurement of the WLAN. For example, the SBP responder selects one measurement time window from available measurement time windows as a target sensing measurement period to initiate the sensing measurement of the WLAN.

Optionally, the first radio frame includes an SBP request frame.

In returning to FIG. 1, step 102, the first radio frame is transmitted.

The SBP initiator transmits the first radio frame to the SBP responder. After the first radio frame is received, the SBP responder serves as proxy for the SBP initiator to initiate TB sensing measurement to the sensing responder according to the sensing measurement period included in the first radio frame.

Optionally, the SBP initiator may also act as a sensing responder to participate in the TB sensing measurement process initiated by the SBP initiator.

Further, the SBP responder initiates sensing measurement of the WLAN as SBP proxy. The initiated sensing measurement of the WLAN is TB sensing measurement. The TB sensing measurement is divided into a NDPA sounding (downlink (DL)) sensing measurement process and a trigger frame sounding (uplink (UL)) sensing measurement process.

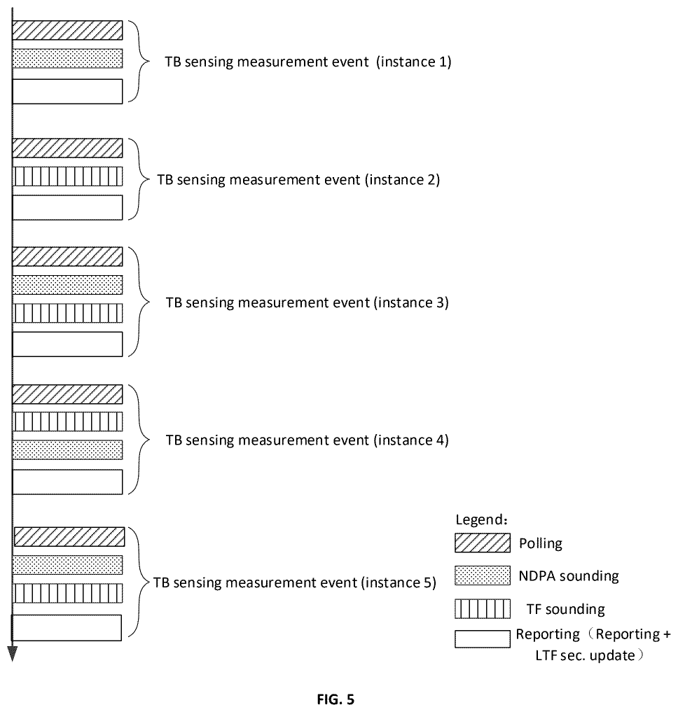

A WLAN sensing process generally includes a triggered based (TB) sounding method and a non-TB sensing method. Specifically, in the TB sensing measurement method, the AP is an initiator or a transmitter. In the non-TB sensing measurement method, the STA is an initiator or a transmitter. As a second instance, the TB sensing measurement process is shown in FIG. 5. FIG. 5 shows a plurality of sensing measurement events of a TB sensing measurement process. In instances 1-5, the sensing measurement process includes polling, sounding, and reporting (reporting+LTF sec. update) processes. In each instance, the sounding may include only NDPA sounding or TF sounding, or may include both of them. The SBP initiator may participate in NDPA sounding.

In the examples of the present disclosure, the SBP initiator includes at least one sensing measurement period in the first radio frame. The sensing measurement period is configured for the SBP responder to serve as proxy for the SBP initiator to establish the sensing measurement of the wireless local area network (WLAN). Thus, the SBP responder selects one sensing measurement period as a target sensing measurement period from available measurement time windows after receiving the first radio frame to initiate the sensing measurement of the WLAN. A method of negotiating a measurement period during SBP is implemented, so as to perfect an SBP establishment mechanism.

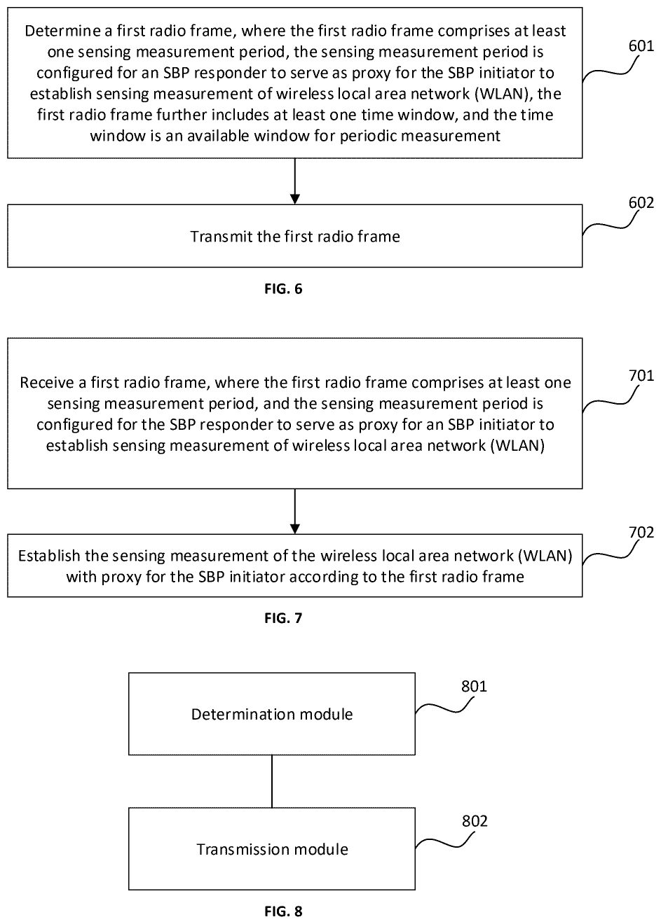

With reference to FIG. 6, the examples of the present disclosure provide a communication method. Optionally, the method may be performed by a sensing by proxy (SBP) initiator, such as a station (STA) device. The method may include steps 601 and 602.

Step 601, a first radio frame is determined, where the first radio frame includes at least one sensing measurement period, and the sensing measurement period is configured for an SBP responder to serve as proxy for the SBP initiator to establish sensing measurement of wireless local area network (WLAN). Optionally, a sensing measurement period identification bit may be included in the first radio frame. For example, in a case that the sensing measurement period identification bit is 1, it indicates that the sensing measurement occurs once; or in a case that the sensing measurement period identification bit is greater than 1, for example, N, it indicates that the sensing measurement occurs N times.

The first radio frame further includes at least one time window. The time window is an available window for periodic measurement, that is, an available time window for measurement. One or more available time windows may be provided. In a case of a plurality of time windows, each time window may separately identify a time point at which the SBP initiator participates in the sensing measurement or receives the sensing measurement report, or participates in the sensing measurement and receives the sensing measurement report simultaneously.

The time window may be configured for the SBP initiator to participate in the measurement or receive an SBP measurement report. The SBP responder may select one time point from the time window as start time point of the sensing measurement to establish sensing measurement with the sensing responder.

Step 602, the first radio frame is transmitted.

The examples of the present disclosure provide a communication method. Optionally, the method may be performed by a sensing by proxy (SBP) initiator, such as a station (STA) device. The method may include:
a first radio frame is determined, where the first radio frame includes at least one sensing measurement period, the sensing measurement period is configured for an SBP responder to serve as proxy for the SBP initiator to establish sensing measurement of wireless local area network (WLAN), the first radio frame further includes at least one time window, and the time window is an available window for periodic measurement; and the first radio frame is transmitted.

In a case that the first radio frame includes one time window, the time window is configured for the SBP initiator to participate in the sensing measurement of the WLAN or receive a sensing measurement report; and
in a case that the first radio frame includes two time windows, the two time windows are configured for the SBP initiator to participate in the sensing measurement of the WLAN and receive a sensing measurement report respectively.

Setting of the time window may include three cases.

Case 1: in a case that the first radio frame only includes one time window, the time window is configured for the SBP initiator to participate in the sensing measurement of the WLAN. The SBP initiator participates in the sensing measurement of the WLAN in the time window. The sensing measurement may be established by the SBP responder with the SBP initiator within the time window.

Case 2: in a case that the first radio frame only includes one time window, the time window is configured for the SBP initiator to receive the sensing measurement report. The sensing measurement report is received within the time window by the SBP initiator. The sensing measurement report may be transmitted within the time window by the SBP responder.

Case 3: in a case that the first radio frame includes at least two time windows, the two time windows are configured for the SBP initiator to participate in the sensing measurement of the WLAN and receive the sensing measurement report respectively. The SBP initiator may further identify a specific time window for participating in the sensing measurement of the WLAN and a specific time window for receiving the sensing measurement report.

The examples of the present disclosure provide a communication method. Optionally, the method may be performed by a sensing by proxy (SBP) initiator, such as a station (STA) device. The method may include:
a first radio frame is determined, where the first radio frame includes at least one sensing measurement period, the sensing measurement period is configured for an SBP responder to serve as proxy for the SBP initiator to establish sensing measurement of wireless local area network (WLAN), and optionally, the first radio frame includes an SBP request frame; the first radio frame is transmitted; a second radio frame transmitted by the SBP responder is received, where optionally, the second radio frame includes an SBP response frame; and time information and a time synchronization function timer (TSF timer) value included in the second radio frame are obtained, where the time information is start time for establishing a target sensing measurement period of the sensing measurement of the WLAN by the SBP responder. The SBP responder selects one time value from the time window as the start time for establishing the target sensing measurement period of the sensing measurement of the WLAN, that is, time indicated by the time information.

The TSF timer value is used to maintain time synchronization of the SBP initiator and the SBP responder.

In an optional example, after the time information and the time synchronization function timer (TSF timer) value included in the second radio frame are obtained, the method further includes:
time synchronization is maintained with the SBP responder according to the TSF timer value.

The SBP initiator maintains time synchronization with the SBP responder according to the TSF timer value.

In the examples of the present disclosure, the SBP initiator includes at least one sensing measurement period in the first radio frame. The sensing measurement period is configured for the SBP responder to serve as proxy for the SBP initiator to establish the sensing measurement of the wireless local area network (WLAN). Thus, the SBP responder selects one sensing measurement period as a target sensing measurement period from available measurement time windows after receiving the first radio frame to initiate the sensing measurement of the WLAN. A method of negotiating a measurement period during SBP is implemented, so as to perfect an SBP establishment mechanism.

With reference to FIG. 7, the examples of the present disclosure provide a communication method. Optionally, the method may be performed by a sensing by proxy (SBP) responder, such as a station (STA) device. The method may include steps 701 and 702.

Step 701, a first radio frame is determined, where the first radio frame includes at least one sensing measurement period, and the sensing measurement period is configured for the SBP responder to serve as proxy for an SBP initiator to establish sensing measurement of wireless local area network (WLAN).

Reference is made to the first instance for the architecture of the WLAN sensing and the WLAN sensing process applied to the communication method provided in the example of the present disclosure, which is not repeated here.

Generally, when acting as a sensing initiator or a sensing transmitter, the STA does not have a function of communicating with a plurality of receivers simultaneously, such that a proxy device (for example, AP) is required to serve as proxy for the STA to perform triggered based sounding (TB) sensing measurement, so as to improve efficiency of sensing measurement.

During SBP, the SBP initiator may have parameter requirements for trigger-based (TB) sensing measurement, such as a number of sensing responders participating in TB sensing measurement, bandwidth of sensing measurement, a number of spatial streams supported by sensing measurement, and time period information of measurement. The SBP initiator may carry one or more pieces of information about the sensing measurement period required by the SBP initiator in the first radio frame, for example, a number of required sensing measurement periods. For another example, a sensing measurement period identification bit may be included in the first radio frame. For example, in a case that the sensing measurement period identification bit is 1, it indicates that the sensing measurement occurs once; or in a case that the sensing measurement period identification bit is greater than 1, for example, N, it indicates that the sensing measurement occurs N times. The sensing measurement period is configured for the SBP responder to serve as proxy for the SBP initiator to establish the sensing measurement of the WLAN. For example, the SBP responder selects one measurement time window from available measurement time windows as a target sensing measurement period to initiate the sensing measurement of the WLAN.

Optionally, the first radio frame includes an SBP request frame. The SBP responder receives the first radio frame and initiates the sensing measurement according to the required information about the sensing measurement period in the first radio frame.

Step 702, the sensing measurement of the wireless local area network (WLAN) is established with proxy for the SBP initiator according to the first radio frame.

After the first radio frame is received, the SBP responder serves as proxy for the SBP initiator to initiate TB sensing measurement to the sensing responder according to the sensing measurement period included in the first radio frame.

Optionally, the SBP initiator may also act as a sensing responder to participate in the TB sensing measurement process initiated by the SBP initiator.

Further, the SBP responder initiates sensing measurement of the WLAN as SBP proxy. The initiated sensing measurement of the WLAN is TB sensing measurement. The TB sensing measurement is divided into a NDPA sounding (downlink (DL)) sensing measurement process and a trigger frame sounding (uplink (UL)) sensing measurement process.

A WLAN sensing process generally includes a trigger based (TB) sounding method and a non-TB sensing method. Specifically, in the TB sensing measurement method, the AP is an initiator or a transmitter. In the non-TB sensing measurement method, the STA is an initiator or a transmitter. The TB sensing measurement process is described in the foregoing second instance, which is not repeated here.

In the examples of the present disclosure, the SBP responder receives the first radio frame and obtains at least one sensing measurement period included in the first radio frame. The sensing measurement period is configured for the SBP responder to serve as proxy for the SBP initiator to establish the sensing measurement of the wireless local area network (WLAN). The SBP responder selects one sensing measurement period as a target sensing measurement period from available measurement time windows after receiving the first radio frame to initiate the sensing measurement of the WLAN. A method of negotiating a measurement period during SBP is implemented, so as to perfect an SBP establishment mechanism.

In an optional example, the first radio frame further includes at least one time window, and the time window is an available window for periodic measurement, that is, a time window allowing measurement.

The time window may be configured for the SBP initiator to participate in the measurement or receive an SBP measurement report. The SBP responder may select one time point from the time window as start time point of the sensing measurement to establish sensing measurement with the sensing responder.

In an optional example, in a case that the first radio frame includes one time window, the time window is configured for the SBP responder to establish the sensing measurement of the WLAN with the SBP initiator or transmit a sensing measurement report to the SBP initiator; and
in a case that the first radio frame includes two time windows, the two time windows are configured for the SBP responder to establish the sensing measurement of the WLAN with the SBP initiator and transmit a sensing measurement report to the SBP initiator respectively.

Setting of the time window may include three cases.

Case 1: in a case that the first radio frame only includes one time window, the time window is configured for the SBP initiator to participate in the sensing measurement of the WLAN. The SBP initiator participates in the sensing measurement of the WLAN in the time window. The sensing measurement may be established by the SBP responder with the SBP initiator within the time window.

Case 2: in a case that the first radio frame only includes one time window, the time window is configured for the SBP initiator to receive the sensing measurement report. The sensing measurement report is received within the time window by the SBP initiator. The sensing measurement report may be transmitted within the time window by the SBP responder.

Case 3: in a case that the first radio frame includes at least two time windows, the two time windows are configured for the SBP initiator to participate in the sensing measurement of the WLAN and receive the sensing measurement report respectively. The SBP initiator may further identify a specific time window for participating in the sensing measurement of the WLAN and a specific time window for receiving the sensing measurement report.

The examples of the present disclosure provide a communication method. Optionally, the method may be performed by a sensing by proxy (SBP) responder, such as a station (STA) device. The method may include:
a first radio frame is received, where the first radio frame includes at least one sensing measurement period, and the sensing measurement period is configured for the SBP responder to serve as proxy for an SBP initiator to establish sensing measurement of wireless local area network (WLAN); and time information is selected from the time window as start time for establishing a target sensing measurement period of the sensing measurement of the WLAN; the time information and a time synchronization function timer (TSF timer) value are included in a second radio frame, and the second radio frame is transmitted to the SBP initiator.

The second radio frame includes an SBP response frame. The time information is start time for establishing a target sensing measurement period of the sensing measurement of the WLAN by the SBP responder. The SBP responder selects one time value from the time window as the start time for establishing the target sensing measurement period of the sensing measurement of the WLAN, that is, time indicated by the time information.

The TSF timer value is used to maintain time synchronization of the SBP initiator and the SBP responder.

The examples of the present disclosure provide a communication method. Optionally, the method may be performed by a sensing by proxy (SBP) responder, such as a station (STA) device. The method may include:
a first radio frame is received, where the first radio frame includes at least one sensing measurement period, and the sensing measurement period is configured for the SBP responder to serve as proxy for an SBP initiator to establish sensing measurement of wireless local area network (WLAN); the at least one sensing measurement period is included in a sensing measurement request frame, and the sensing measurement request frame is transmitted to a station device within preset timeout time; time information is selected from the time window as start time for establishing a target sensing measurement period of the sensing measurement of the WLAN; and the time information and a time synchronization function timer (TSF timer) value are included in a second radio frame, and the second radio frame is transmitted to the SBP initiator.

Within known timeout time (for example, 10 ms) of the SBP initiator and the SBP responder, a sensing measurement process is established by the SBP responder with the sensing responder (for example, an STA) according to requirements of the SBP initiator. A value set for the sensing measurement period in a sensing measurement request frame is consistent with a value in the first radio frame (SBP request frame). The SBP responder selects one time value from the time window of the SBP request frame (as a start time point of the sensing measurement) according to a communication condition of the STA to establish the sensing measurement process with the STA. After the sensing measurement is established, the SBP responder replies a second radio (SBP response) frame to the SBP initiator. The SBP response frame contains a negotiated start time point and also includes a time synchronization function timer (TSF timer) value, which is configured for the STA (SBP initiator) and the AP to maintain time synchronization. The TSF timers in the sensing measurement of the AP and the STA are consistent.

The examples of the present disclosure provide a communication method. Optionally, the method may be performed by a sensing by proxy (SBP) responder, such as a station (STA) device. The method may include:
a first radio frame is received, where the first radio frame includes at least one sensing measurement period, and the sensing measurement period is configured for the SBP responder to serve as proxy for an SBP initiator to establish sensing measurement of wireless local area network (WLAN); and time information is selected from the time window as start time for establishing a target sensing measurement period of the sensing measurement of the WLAN; the time information and a time synchronization function timer (TSF timer) value are included in a second radio frame, and the second radio frame is transmitted to the SBP initiator; and the at least one sensing measurement period is included in a sensing measurement request frame, and the sensing measurement request frame is transmitted to a station device within preset timeout time.

The SBP responder selects one time value from the time window of the first radio frame (SBP request frame) as a start time point of the sensing measurement according to a communication condition of the STA. The SBP responder replies a second radio (SBP response) frame to the SBP initiator. The SBP response frame contains a negotiated start time point and also includes a time synchronization function timer (TSF timer) value, which is configured for the STA (SBP initiator) and the AP to maintain time synchronization. The TSF timers in the sensing measurement of the AP and the STA are consistent.

Then, within known timeout time (for example, 10 ms) of the SBP initiator and the SBP responder, a sensing measurement process is established by the SBP responder with the sensing responder (for example, an STA) according to requirements of the SBP initiator. A value set for the sensing measurement period in a sensing measurement request frame is consistent with a value in the first radio frame (SBP request frame).

In the examples of the present disclosure, the SBP responder receives the first radio frame and obtains at least one sensing measurement period included in the first radio frame. The sensing measurement period is configured for the SBP responder to serve as proxy for the SBP initiator to establish the sensing measurement of the wireless local area network (WLAN). The SBP responder selects one sensing measurement period as a target sensing measurement period from available measurement time windows after receiving the first radio frame to initiate the sensing measurement of the WLAN. A method of negotiating a measurement period during SBP is implemented, so as to perfect an SBP establishment mechanism.

With reference to FIG. 8, based on a same principle as the method provided in the examples of the present disclosure, the examples of the present disclosure further provide an electronic device. The electronic device is a sensing by proxy (SBP) initiator. The electronic device includes: a determination module 801 and a transmission module 802.

The determination module 801, configured to determine a first radio frame, where the first radio frame includes at least one sensing measurement period, and the sensing measurement period is configured for an SBP responder to serve as proxy for the SBP initiator to establish sensing measurement of wireless local area network (WLAN).

The transmission module 802, configured to transmit the first radio frame.

In an optional example, the first radio frame further includes at least one time window, and the time window is an available window for periodic measurement.

In an optional example, in a case that the first radio frame includes one time window, the time window is configured for the SBP initiator to participate in the sensing measurement of the WLAN or receive a sensing measurement report; and
in a case that the first radio frame includes two time windows, the two time windows are configured for the SBP initiator to participate in the sensing measurement of the WLAN and receive a sensing measurement report respectively.

In an optional example, the electronic device further includes:
a second reception module, configured to receive a second radio frame transmitted by the SBP responder; and an information obtaining module, configured to obtain time information and a time synchronization function timer (TSF timer) value included in the second radio frame, where the time information is start time for establishing a target sensing measurement period of the sensing measurement of the WLAN by the SBP responder.

In an optional example, the electronic device further includes:
a time synchronizing module, configured to maintain time synchronization with the SBP responder according to the TSF timer value.

In an optional example, the first radio frame includes an SBP request frame; and/or the second radio frame includes an SBP response frame.

In the examples of the present disclosure, the determination module 801 includes at least one sensing measurement period in the first radio frame. The transmission module 802 transmits the first radio frame. The sensing measurement period is configured for the SBP responder to serve as proxy for the SBP initiator to establish the sensing measurement of the wireless local area network (WLAN). Thus, the SBP responder selects one sensing measurement period as a target sensing measurement period from available measurement time windows after receiving the first radio frame to initiate the sensing measurement of the WLAN. A method of negotiating a measurement period during SBP is implemented, so as to perfect an SBP establishment mechanism.

The example of the present disclosure further provides a device for communication. The device is applied to a sensing by proxy (SBP) initiator and includes:
a radio frame determining module, configured to determine a first radio frame, where the first radio frame includes at least one sensing measurement period, and the sensing measurement period is configured for an SBP responder to serve as proxy for the SBP initiator to establish sensing measurement of wireless local area network (WLAN); and a radio frame transmitting module, configured to transmit the first radio frame.

The device further includes other modules of the electronic device in the foregoing example, which are not repeated here.

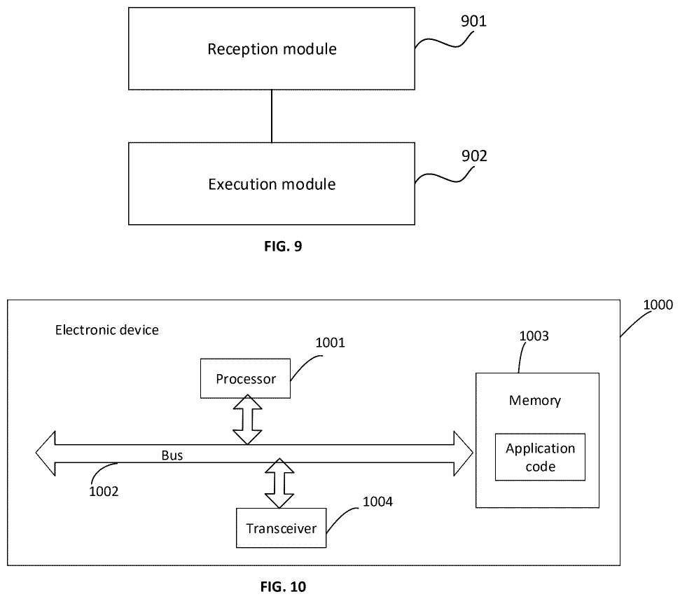

With reference to FIG. 9, based on a same principle as the method provided in the examples of the present disclosure, the examples of the present disclosure further provide an electronic device. The electronic device is a sensing by proxy (SBP) responder. The electronic device includes: a reception module 901 and an execution module 902.

The reception module 901 is configured to receive a first radio frame, where the first radio frame includes at least one sensing measurement period, and the sensing measurement period is configured for the SBP responder to serve as proxy for an SBP initiator to establish sensing measurement of wireless local area network (WLAN).

The execution module 902 is configured to serve as proxy for the SBP initiator to establish the sensing measurement of the wireless local area network (WLAN) according to the first radio frame.

In an optional example, the first radio frame further includes at least one time window, and the time window is an available window for periodic measurement.

In an optional example, in a case that the first radio frame includes one time window, the time window is configured for the SBP responder to establish the sensing measurement of the WLAN with the SBP initiator or transmit a sensing measurement report to the SBP initiator; and in a case that the first radio frame includes two time windows, the two time windows are configured for the SBP responder to establish the sensing measurement of the WLAN with the SBP initiator and transmit a sensing measurement report to the SBP initiator respectively.

In an optional example, the execution module 902 is configured to:
select time information from the time window as start time for establishing a target sensing measurement period of the sensing measurement of the WLAN; and carry the time information and a time synchronization function timer (TSF timer) value in a second radio frame, and transmit the second radio frame to the SBP initiator.

In an optional example, the electronic device further includes:
a request transmitting module, not shown, configured to carry, before the second radio frame is transmitted to the SBP initiator by the execution module 902 or after the second radio frame is transmitted to the SBP initiator by the execution module 902, the at least one sensing measurement period in a sensing measurement request frame, and transmit the sensing measurement request frame to a station device within preset timeout time.

In an optional example, the first radio frame includes an SBP request frame; and/or the second radio frame includes an SBP response frame.

In the examples of the present disclosure, the reception module 901 receives the first radio frame and obtains the at least one sensing measurement period included in the first radio frame. The sensing measurement period is configured for the SBP responder to serve as proxy for the SBP initiator to establish the sensing measurement of the wireless local area network (WLAN). Thus the execution module 902 selects one sensing measurement period as a target sensing measurement period from available measurement time windows to initiate the sensing measurement of the WLAN. A method of negotiating a measurement period during SBP is implemented, so as to perfect an SBP establishment mechanism.

The example of the present disclosure further provides a device for communication. The device is applied to an SBP responder and includes:
a radio frame receiving module, configured to receive a first radio frame, where the first radio frame includes at least one sensing measurement period, and the sensing measurement period is configured for the SBP responder to serve as proxy for an SBP initiator to establish sensing measurement of wireless local area network (WLAN); and an SBP executing module, configured to serve as proxy of the SBP initiator to establish the sensing measurement of the wireless local area network (WLAN) according to the first radio frame.

The device further includes other modules of the electronic device in the foregoing example, which are not repeated here.

In an optional example, the example of the present disclosure further provides an electronic device as shown in FIG. 10. The electronic device 1000 shown in FIG. 10 may be a server, and includes a processor 1001 and a memory 1003. The processor 1001 is connected to the memory 1003, for example, via a bus 1002. Optionally, the electronic device 1000 may further include a transceiver 1004. It should be noted that in practical application, the transceiver 1004 is not limited to one. A structure of the electronic device 1000 does not constitute a limitation to the example of the present disclosure.

The processor 1001 may be a central processing unit (CPU), a general-purpose processor, a digital signal processor (DSP), an application specific integrated circuit (ASIC), a field programmable gate array (FPGA), or other programmable logic devices, transistor logic devices, hardware components, or their any combinations. The processor may implement or execute various illustrative logical blocks, modules, and circuits described in connection with contents disclosed in the present disclosure. The processor 1001 may also be a combination realizing a computation function, for example, a combination encompassing one or more microprocessors, a combination of a DSP and a microprocessor, etc.

The bus 1002 may include a path to transfer information between the components. The bus 1002 may be a peripheral component interconnect (PCI) bus, an extended industry standard architecture (EISA) bus, etc. The bus 1002 may be classified into an address bus, a data bus, a control bus, and the like. For ease of presentation, the bus is shown with only one thick line in FIG. 10, but it does not indicate that there is only one bus or one type of buses.

The memory 1003 may be a read only memory (ROM) or another type of static storage device capable of storing static information and instructions, a random access memory (RAM) or another type of dynamic storage devices capable of storing information and instructions, an electrically erasable programmable read only memory (EEPROM), a compact disc read only memory (CD-ROM) or another optical disk storage, optical disk storage (including a compact disc, a laser disc, an optical disc, a digital versatile disc, a Blue-ray disc, etc.), a magnetic disk storage medium or another magnetic storage device, or any other media that may be configured to carry or store desired program codes in a form of instructions or data structures and that may be accessed by a computer, but is not limited to this.

The memory 1003 is configured to store an application code for executing the solutions of the present disclosure, and execution is controlled by the processor 1001. The processor 1001 is configured to execute the application code stored in the memory 1003, so as to implement the content shown in the foregoing method examples.

The electronic device 1000 includes, but is not limited to, a mobile terminal such as a mobile phone, a notebook computer, a digital stream receiver, a personal digital assistant (PDA), a portable android device (PAD), a portable multimedia player (PMP), and an in-vehicle terminal (for example, an in-vehicle navigation terminal), and a fixed terminal such as a digital television (TV) and a desktop computer. The electronic device 1000 illustrated in FIG. 10 is merely an instance and should not impose any limitation on the functions and scope of use of the examples of the present disclosure.

The server provided in the present disclosure may be an independent physical server, a server cluster or a distributed system composed of a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be a smart phone, a tablet computer, a notebook computer, a desktop computer, a smart slightly speaker, a smart watch, etc., but is not limited to this. The terminal and the server may be connected directly or indirectly through wired or wireless communication, which is not limited in the present disclosure.

The examples of the present disclosure provide a non-transitory computer-readable storage medium. The non-transitory computer-readable storage medium stores a computer program. When run on a computer, the computer program causes the computer to perform the corresponding contents in the foregoing method examples.

It should be understood that while all the steps in the flowcharts of the accompanying drawings are shown sequentially as indicated by arrows, the steps are not necessarily performed sequentially in an order indicated by the arrows. Unless explicitly stated here, an execution order of these steps is no strictly limited, and these steps can be performed in other orders. Moreover, at least some of the steps in the flowcharts of the accompanying drawings can include a plurality of sub-steps or stages. These sub-steps or stages are not necessarily performed at the same time, but can be performed at different times. These sub-steps or stages are not necessarily performed sequentially, but can be performed in turn or alternately with other steps or at least some of sub-steps or stages of other steps.

It should be noted that the non-transitory computer-readable medium in the present disclosure may be a non-transitory computer-readable signal medium or a non-transitory computer-readable storage medium, or any combination of a computer-readable signal medium and a computer-readable storage medium. The non-transitory computer-readable storage medium may include, but is not limited to, an electronic, magnetic, optical, electromagnetic, infrared, or semiconductor system, apparatus, or device, or any combination of the foregoing. More specific instance of the non-transitory computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the non-transitory computer-readable storage medium may be any tangible medium that includes or stores a program for use by or in conjunction with an instruction execution system, apparatus, or device. In the present disclosure, the compute-readable signal medium may include a data signal propagating in a baseband or as part of a carry wave and carrying a computer-readable program code. Such a propagated data signal may have a variety of forms and may include, but is not limited to, an electromagnetic signal, an optical signal, or any suitable combination of the foregoing. The non-transitory computer-readable signal medium may also be any computer-readable medium besides a computer-readable storage medium. The non-transitory computer-readable signal medium can transmit, propagate, or transfer a program for use by or in conjunction with an instruction execution system, apparatus, or device. A program code included on a non-transitory computer-readable medium may be transferred by means of any suitable medium, including, but not limited to, wires, fiber optic cables, radio frequency (RF), etc., or any suitable combination of the foregoing.

The non-transitory computer-readable medium may be included in the above electronic device 1000, and may also exist independently without being installed into the electronic device 1000.

The non-transitory computer-readable medium includes one or more programs. When the one or more programs executed by the electronic device 1000, cause the electronic device 1000 to perform the method shown in the example(s).

According to an aspect of the present disclosure, a computer program product or a computer program is further provided. The computer program product or the computer program includes computer instructions. The computer instructions are stored in a computer-readable storage medium. A processor of a computer device reads the computer instructions from the computer-readable storage medium. The processor executes the computer instructions to cause the computer device to perform the methods of the optional embodiments described.

A computer program code for performing operations of the present disclosure may be written in one or more programming languages, or combinations of the programming languages. The programming languages include target-oriented programming languages, such as Java, Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected with a user computer through any kind of network, including a local area network (LAN) or a wide area network (WAN), or may be connected with an external computer (for example, connected through the Internet by using an Internet service provider).

The flowcharts and block diagrams in the accompanying drawings illustrate the architecture, functionality, and operations possibly implemented by the systems, methods, and computer program products according to various examples of the present disclosure. In this regard, each block in the flowcharts or block diagrams may represent a module, a program segment, or part of a code, and a module, a program segment, or part of a code includes one or more executable instructions for implementing a specified logical function. It should also be noted that in some alternative implementations, a function noted in a block may occur in an order different from an order noted in the figures. For example, two consecutive blocks may actually be executed substantially in parallel, or in a reverse order sometimes, depending on a function involved. It should also be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The modules described in the example of the present disclosure may be implemented in software or hardware. The name of a module in a case does not constitute a qualification of the module itself, for example, a module A can also be described as “a module A for performing operation B”.

The description is merely illustrative of preferred examples of the present disclosure and principles of the technology employed. It should be understood by those skilled in the art that the disclosed scope involved in the present disclosure is not limited to the technical solutions in which the above-described technical features are specifically combined, but includes other technical solutions in which the above-described technical features or equivalent features are arbitrarily combined without departing from the concept of the present disclosure, for example, technical solutions formed by interchanging the features described above with (non-limitative) technical features disclosed in the present disclosure that have similar functions.

1. A communication method, performed by to a sensing by proxy (SBP) initiator, comprising:
determining a first radio frame, wherein the first radio frame comprises at least one sensing measurement period, and the sensing measurement period is configured for an SBP responder to serve as proxy for the SBP initiator to establish sensing measurement of wireless local area network (WLAN); and
transmitting the first radio frame.

2. The communication method according to claim 1, wherein the first radio frame further comprises at least one time window, and the at least one time window is an available window for periodic measurement.

3. The communication method according to claim 2, wherein
in a case that the first radio frame comprises one time window, the one time window is configured for the SBP initiator to participate in the sensing measurement of the WLAN or receive a sensing measurement report; and
in a case that the first radio frame comprises two time windows, the two time windows are configured for the SBP initiator to participate in the sensing measurement of the WLAN and receive the sensing measurement report respectively.

4. The communication method according to claim 1, wherein after the transmitting the first radio frame, the method further comprises:
receiving a second radio frame transmitted by the SBP responder; and
obtaining time information and a time synchronization function timer (TSF timer) value comprises in the second radio frame, wherein the time information is start time for establishing a target sensing measurement period of the sensing measurement of the WLAN by the SBP responder.

5. The communication method according to claim 4, wherein after obtaining the time information and the TSF timer value comprises in the second radio frame, the method further comprises:
maintaining time synchronization with the SBP responder according to the TSF timer value.

6. The communication method according to claim 4, wherein the method further comprises at least one of:
the first radio frame comprises an SBP request frame; or
the second radio frame comprises an SBP response frame.

7. A communication method, performed by to a sensing by proxy (SBP) responder, comprising:
receiving a first radio frame, wherein the first radio frame comprises at least one sensing measurement period, and the sensing measurement period is configured for the SBP responder to serve as proxy for an SBP initiator to establish sensing measurement of wireless local area network (WLAN); and
establishing the sensing measurement of the wireless local area network (WLAN) with proxy for the SBP initiator according to the first radio frame.

8. The communication method according to claim 7, wherein the first radio frame further comprises at least one time window, and the at least one time window is an available window for periodic measurement.

9. The communication method according to claim 8, wherein in a case that the first radio frame comprises one time window, the one time window is configured for the SBP responder to establish the sensing measurement of the WLAN with the SBP initiator or transmit a sensing measurement report to the SBP initiator; and
in a case that the first radio frame comprises two time windows, the two time windows are configured for the SBP responder to establish the sensing measurement of the WLAN with the SBP initiator and transmit the sensing measurement report to the SBP initiator respectively.

10. The communication method according to claim 8, wherein establishing the sensing measurement of the wireless local area network (WLAN) with proxy for the SBP initiator according to the first radio frame comprises:
selecting time information from the time window as start time for establishing a target sensing measurement period of the sensing measurement of the WLAN; and
carrying the time information and a time synchronization function timer (TSF timer) value in a second radio frame, and transmitting the second radio frame to the SBP initiator.

11. The communication method according to claim 10, wherein before the transmitting the second radio frame to the SBP initiator or after the transmitting the second radio frame to the SBP initiator, the method further comprises:
carrying the at least one sensing measurement period in a sensing measurement request frame, and transmitting the sensing measurement request frame to a station device within preset timeout time.

12. The communication method according to claim 10, wherein the method further comprises at least one of: the first radio frame comprises an SBP request frame; or
the second radio frame comprises an SBP response frame.

13.-14. (canceled)

15. An electronic device, comprising a memory, one or more processors, and a computer program stored on the memory and runnable on the one or more processors, wherein when the computer program executed by the one or more processors, the one or more processors are collectively configured to:
determine a first radio frame, wherein the first radio frame comprises at least one sensing measurement period, and the sensing measurement period is configured for an SBP responder to serve as proxy for the SBP initiator to establish sensing measurement of wireless local area network (WLAN); and
transmit the first radio frame.

16. A non-transitory computer-readable storage medium, storing one or more computer programs configured to be executed by one or more processors of a processing device, and the one or more programs comprise instructions, wherein the instructions, when executed by the processing device, cause the processing device to implements the method according to claims 1.

17. An electronic device, comprising a memory, one or more processors, and a computer program stored on the memory and runnable on the one or more processors, wherein when the computer program executed by the one or more processors, the one or more processors are collectively configured to implement the method according to claim 7.

18. A non-transitory computer-readable storage medium, storing one or more computer programs configured to be executed by one or more processors of a processing device, and the one or more programs comprise instructions, wherein the instructions, when executed by the processing device, cause the processing device to implement the method according to claim 7.
